(19) United States
(12) Patent Application Publication
(10) Pub. No.: US 2026/0176873 A1
(43) Pub. Date: Jun. 25, 2026

(54) ROOFING MEMBRANES WITH IMPROVED BURN RESISTANCE

(71) Applicant: Amrize Technology Switzerland LLC, Zug (CH)

(72) Inventors: Zengquan QIN, Brentwood, TN (US); Jiansheng TANG, Westfield, IN (US); Andrew KINNAIRD, Nashville, TN (US); Donna C. TIPPMANN, Nashville, TN (US)

(21) Appl. No.: 18/998,654

(22) PCT Filed: Jul. 31, 2023
(86) PCT No.: PCT/US2023/071319

§ 371 Date: Jan. 27, 2025

Related U.S. Application Data
(60) Provisional application No. 63/393,485, filed on Jul. 29, 2022.

(51) Int. Cl. E04D 5/06; C08L 23/16; C08L 89/00

(52) U.S. Cl. CPC E04D 5/06; C08L 23/16; C08L 89/00; C08L 2201/02; C08L 2203/16

(57) ABSTRACT

A roofing membrane comprising a cured EPDM rubber matrix having protein-containing powder dispersed therein.

This application claims the benefit of U.S. Provisional Application Ser. No. 63/393,485 filed on Jul. 29, 2022, which is incorporated herein by reference.

### FIELD OF THE INVENTION

The present invention generally relates to EPDM roofing membranes that include protein-containing particulate and demonstrate improved resistance to burning.

### BACKGROUND OF THE INVENTION

Single-ply roofing membranes fabricated from ethylene-propylene-diene terpolymer (EPDM rubber) are widely used to cover flat or low-sloped roofs. Among the several characteristics that these membranes must exhibit in order to function as a roofing membrane is resistance to burning. In this respect, roof systems that including single-ply membranes such as EPDM roofing membranes are classified by ASTM E108-20a or similar standards such as UL 790 (8th Ed. 2004). These classification methodologies include multiple tests that ultimately provide a rating (i.e. Class A, B or C), which suggests the flame resistance of the system. Specifically, where membrane systems are installed over a non-combustible deck, the system is only subjected to the spread of flame test, while membrane systems installed over a combustible desk are subjected to the spread of flame test, the intermittent flame test, and the burning brand test.

While several factors, such as the nature of the deck, play into the ultimate classification, the flame resistance of the EPDM membrane may play a major role in the fire resistance of the system. The flame resistance of EPDM membranes was historically achieved by the addition of flame retardants such halogenated compounds (e.g. decabromodiphenyl oxide). More recently, EPDM membranes with advantageous flame resistance have been achieved by the addition of mineral fillers such as clay, talc, and mica. While useful, limitations exist with regard to the flame resistance of these mineral-filled membranes. That is, there are limits to the level of mineral filler that can be included within the membrane because the mechanical properties of the membrane are deleteriously impacted at higher loadings of these fillers. This is especially problematic for non-reinforced membranes. As a result, advantageous fire ratings are difficult to achieve for roof systems with higher slopes (e.g. 3:12 as opposed to 0.25:12 pitched roofs).

### SUMMARY OF THE INVENTION

One or more embodiments of the present invention provide a roofing membrane comprising a cured EPDM rubber matrix having protein-containing powder dispersed therein.

Other embodiments of the present invention provide a roof system including the roofing membrane comprising a cured EPDM rubber matrix having protein-containing powder dispersed therein.

Yet other embodiments of the present invention provide the use of protein-containing powder in a cured EPDM roofing membrane to increase fire resistance.

### DETAILED DESCRIPTION OF ILLUSTRATIVE EMBODIMENTS

Embodiments of the present invention are based, at least in part, upon the discovery of an EPDM roofing membrane including protein-containing particulate (e.g. soy flour). Advantageously, the membranes of one or more embodiments demonstrate improved flame resistance and can therefore provide roof systems with advantageous ratings under ASTM E108 (20A) (and/or UL 790 (8^{th} Ed. 2004)). Additionally, the improved flame resistance has been realized without a deleterious impact on other characteristics of the membrane, and therefore membranes of this invention meet the performance standards of ASTM D4637 (2021). While the prior art contemplates EPDM membranes that can achieve Class A (ASTM E108 and/or UL 790) over a non-combustible deck by including threshold amounts of mineral filler, it has been discovered that the same or better flame resistance can be achieved with protein-containing particulate with decreased impact on membrane properties relative to mineral fillers.

### Membrane Construction

As suggested above, the membranes of this invention, which may also be referred to as membrane panels or sheets, are EPDM roofing membranes, which generally include a planar body formed from a cured rubber matrix in which other constituents, such as the soy flour, may be dispersed. The membranes may be of a type generally classified as single-ply roofing membranes, and they are therefore adapted to provide a weatherproof exterior surface to a roofing system. The membranes may optionally include a fabric reinforcement (e.g. scrim) embedded within the membrane; i.e. the fabric is sandwiched between rubber layers. In other embodiments, the membranes are without fabric reinforcement. In one or more embodiments, the EPDM sheet meets the performance standards of D4637/D4637M-15 (Reapproved 2021).

In one or more embodiments, the membranes may be characterized by a thickness of greater than 20 mils, in other embodiments greater than 40 mils, and in other embodiments greater than 50 mils. In these or other embodiments, the membranes are characterized by a thickness of less than 120 mils, in other embodiments less than 100 mils, and in other embodiments less than 90 mils. In one or more embodiments, the membranes have a thickness of from about 20 to about 100 mils, in other embodiments from about 35 to about 95 mils, and in other embodiments from about 45 to about 90 mils. In one or more embodiments, the membranes may be characterized by a width of greater than 5 feet, in other embodiments greater than 10 feet, in other embodiments greater than 20 feet, and in other embodiments greater than 30 feet. In these or other embodiments, the membranes are characterized by a width of less than 100 feet, in other embodiments less than 80 feet, and in other embodiments less than 60 feet. In one or more embodiments, the membranes have a width of from about 5 to about 100 feet, in other embodiments from about 10 to about 100 feet, in other embodiments from about 20 to about 80 feet, and in other embodiments from about 30 to about 60 feet.

In one or more embodiments, the membranes, although commonly referred to as single-ply roofing membranes, may include two or more rubber layers that are mated together with an optional scrim disposed between the layers. In particular embodiments, the respective layers may be compositionally distinct. For example, first and second rubber sheets (i.e. layers) may be formed from first and second respective rubber compositions, and then the respective sheets can be mated and further calendered or laminated to one another, optionally with a reinforcing fabric therebetween. The skilled person will recognize, however, that these layers may be integral to the extent that the calendering and/or curing process creates an interface, at some level, and the layers are generally inseparable. Nonetheless, reference can be made to the individual layers, especially where the layers derive from distinct compositions. Reference may also be made a multi-layered sheet. Relative to the overall thickness, the thickness of the respective layers (regardless of whether or not they are compositionally distinct), may vary. In one or more embodiments, the thickness of the individual layers of a membrane panel including two rubber layers may be half or approximately half of the overall thickness less any increase in thickness resulting from the scrim. In one or more embodiments, each layer of a two-layered membrane may account for from about 40 to about 60% of the overall thickness with the balance being the other rubber layer and the scrim.

In one or more embodiments, each layer of a multi-layered membrane or sheet may include protein-containing particulate according to the present invention. In other embodiments, a first layer may include protein-containing particulate and a second layer is devoid or substantially devoid of protein-containing particulate. Substantially devoid refers to the absence of that amount of protein-containing particulate that would otherwise have an appreciable impact on practice of the present invention. For example, in one embodiment, the membrane of the invention is a calendered sheet wherein a first composition including protein-containing particulate is calandered to form a first layer of the membrane, and a second composition that devoid or substantially devoid of protein-containing particulate is calandered to form a second layer of the membrane. In particular embodiments, the protein-containing particulate is located in the weather-facing layer of the membrane. In other embodiments, the protein-containing particulate is not in the weather-facing side of the membrane.

In one or more embodiments, the membranes of the present invention are two-layered membranes, wherein the first membrane is black in color and the second layer is non-black in color (e.g. white or generally white). As those skilled in the art appreciate, the black layer can derive from a black composition that would generally include carbon black as a filler. The black layer includes protein-containing particulate as contemplated by the present invention. The white layer can derive from a white composition that would generally include non-black fillers such as silica, titanium dioxide, and/or clay. White EPDM membranes or membranes having a white EPDM layer are known in the art as disclosed in U.S. Pat. No. 8,367,760, which is incorporated herein by reference.

### Membrane Composition

The composition of the membranes of this invention can be understood with reference to the constituents of the vulcanizable (i.e. curable) composition used to form the membranes. As will be described in greater detail below, the vulcanizable composition is formed and shaped into the desired shape of the membrane, and then the membrane is cured to form the cured rubber matrix in which the other constituents, such as the protein-containing particulate, are dispersed. The skilled person also understands that a membrane may be constructed by combining two or more layers (typically prior to curing), and each layer may derive from separate vulcanizable compositions. Where the membranes of this invention are prepared by combining multiple rubbers layers, at least one of the layers may include protein-containing particulate according to embodiments of this invention. The other layers may be conventional in nature and are adapted to be compatible with the one or more layers including the protein-containing particulate. In particular embodiments, the one or more of the other layers may be devoid of protein-containing particulate.

In one or more embodiments, the vulcanizable compositions include EPDM, a curative for the EPDM, protein-containing particulate, and a filler. Additionally, the vulcanizable compositions may optionally include and extender, oil, wax, antioxidant, antiozonant, and a combination of two or more thereof. In particular embodiments, the vulcanizable compositions are devoid of halogenated compounds, particularly halogenated flame retardants. In particular embodiments, the vulcanizable compositions include a complementary flame retardant. In sub embodiments thereof, the complementary flame retardant is a non-halogenated flame retardant.

### EPDM Rubber

The skilled person understands that EPDM refers to an olefinic terpolymer rubber polymer (which may also be referred to as a curable polymer or an elastomeric terpolymer). In one or more embodiments, the olefinic terpolymer includes mer units that derive from ethylene, α-olefin, and optionally diene monomer. Useful α-olefins include propylene. In one or more embodiments, the diene monomer may include dicyclopentadiene, alkyldicyclopentadiene, 1,4-pentadiene, 1,4-hexadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-vinyl-2-norbornene, 5-n-propylidene-2-norbornene, 5-(2-methyl-2-butenyl)-2-norbornene, and mixtures thereof. Olefinic terpolymers and methods for their manufacture are known as disclosed at U.S. Pat. No. 3,280,082 as well as U.S. Publication No. 2006/0280892, both of which are incorporated herein by reference. Furthermore, olefinic terpolymers and methods for their manufacture as related to non-black membranes are known as disclosed in U.S. Pat. Nos. 8,367,760 and 8,791,193, which are also incorporated herein by reference. For purposes of this specification, elastomeric terpolymers may simply be referred to as EPDM or EPDM rubber.

In one or more embodiments, the elastomeric terpolymer may include greater than 55 wt %, and in other embodiments greater than 64 wt % mer units deriving from ethylene; in these or other embodiments, the elastomeric terpolymer may include less than 71 wt %, and in other embodiments less than 69 wt %, mer units deriving from ethylene. In one or more embodiments, the elastomeric terpolymer may include greater than 1.5 wt %, in other embodiments greater than 2.4 wt %, mer units deriving from diene monomer; in these or other embodiments, the elastomeric terpolymer may include less than 6 wt %, in other embodiments less than 5 wt %, and in other embodiments less than 4 wt %, mer units deriving from diene monomer. In one or more embodiments, the balance of the mer units derive from propylene or other α-olefins. The elastomeric terpolymers may be characterized and include cure systems as is known in the art and as disclosed in U.S. Publication No. 2006/0280892, incorporated herein by reference.

As is known in the art, it is within the scope of the present invention to blend low Mooney EPDM terpolymers with high Mooney EPDM terpolymers to reduce the overall viscosity of the membrane compound. In other words, EPDM terpolymers with different molecular weights may be utilized to accommodate processing.

### Curative

As indicated above, the vulcanizable composition includes a curative that serves to cure or crosslink the rubber. Those skilled in the art appreciate that EPDM can be cured by using numerous techniques such as those that employ sulfur cure systems, peroxide cure systems, and quinone-type cure systems. The sulfur cure systems may be employed in combination with vulcanizing accelerators.

In one or more embodiments, sulfur and sulfur-containing cure systems may be used (optionally together with an accelerator). Suitable amounts of sulfur can be readily determined by those skilled in the art. In one or more embodiments from about 0.5 to about 1.5 part by weight (pbw) sulfur per 100 parts by weight rubber (phr) may be used. The amount of accelerator can also be readily determined by those skilled in the art.

Useful vulcanizing accelerators include thioureas such as ethylene thiourea, N,N-dibutylthiourea, N,N-diethylthiourea and the like; thiuram monosulfides and disulfides such as tetramethylthiuram monosulfide (TMTMS), tetrabutylthiuram disulfide (TBTDS), tetramethylthiuram disulfide (TMTDS), tetraethylthiuram monosulfide (TETMS), dipentamethylenethiuram hexasulfide (DPTH) and the like; benzothiazole sulfenamides such as N-oxydiethylene-2-benzothiazole sulfenamide, N-cyclohexyl-2-benzothiazole sulfenamide, N,N-diisopropyl-2-benzothiazolesulfenamide, N-tert-butyl-2-benzothiazole sulfenamide (TBBS) (available as Delac® NS from Chemtura, Middlebury, CT) and the like; other thiazole accelerators such as 2-mercaptobenzothiazole (MBT), benzothiazyl disulfide (MBTS), N,N-diphenylguanidine, N,N-di-(2-methylphenyl)-guanidine, 2-(morpholinodithio)benzothiazole disulfide, zinc 2-mercaptobenzothiazole and the like; dithiocarbamates such as tellurium diethyldithiocarbamate, copper dimethyldithiocarbamate, bismuth dimethyldithiocarbamate, cadmium diethyldithiocarbamate, lead dimethyldithiocarbamate, sodium butyldithiocarbamate, zinc diethyldithiocarbamate, zinc dimethyldithiocarbamate, zinc dibutyldithiocarbamate (ZDBDC), dithiophosphates, and mixtures thereof. Sulfur donor-type accelerators (e.g. di-morpholino disulfide and alkyl phenol disulfide) may be used in place of elemental sulfur or in conjunction with elemental sulfur if desired.

Examples of suitable peroxides that can be used as curing agents or co-curing agents include alpha-cumyl hydroperoxide, methylethylketone peroxide, hydrogen peroxide, acetylacetone peroxide, t-butyl hydroperoxide, t-butyl peroxybenzoate, 2,5-bis(t-butyl peroxy)-2,5-dimethylhexene, lauryl peroxide, benzoyl peroxide, 2,4-dichlorobenzoyl peroxide, dibenzoyl peroxide, bis(p-monomethylene-benzoyl) peroxide, bis(p-nitrobenzoyl) peroxide, phenylacetyl peroxide, and mixtures thereof.

Examples of inorganic peroxides that can be used as co-curing agents with p-quinone dioxime include lead peroxide, zinc peroxide, barium peroxide, copper peroxide, potassium peroxide, silver peroxide, sodium peroxide, calcium peroxide, metallic peroxyborates, peroxychromates, peroxydicarbonates, peroxydiphosphates, peroxydisulfates, peroxygermanates, peroxymolybdates, peroxynitrates, magnesium peroxide, sodium pyrophosphate peroxide, and mixtures thereof.

Examples of polysulfide activators for the quinone-type co-curing agents include calcium polysulfide, sodium polysulfide, as well as organic polysulfides having the general formula R—(S)ₓ—R, wherein R is a hydrocarbon group and x is a number from 2-4. Examples of organic polysulfides are disclosed in U.S. Pat. No. 2,619,481, which is incorporated herein by reference.

Where radiation curing is employed to crosslink the rubber, an ionizing crosslinking promoters may be included in lieu of or in addition to the curatives described above. These ionizing crosslinking promoters may include, but are limited to, liquid high-vinyl 1,2-polybutadiene resins containing 90 percent 1,2-vinyl content, ethylene glycol dimethacrylate, dicumyl peroxide (typically about 98 percent active), and pentaerythritol resin prepared from tall oil.

### Protein-Containing Particulate

As indicated above, the vulcanizable composition includes a protein-containing particulate, which may also be referred to as a protein-containing powder. In one or more embodiments, the protein-containing particulate is advantageously sourced from biological sources (i.e. bio sourced). Examples of useful protein-containing particulate include soy flour, chicken feather powder, and pig hair powder.

In one or more embodiments, the protein-containing powder is soy flour, which may also be referred to as soy meal, soy protein, soy grits, soy flakes, and soy powder. Those skilled in the art appreciate that the term soy is used interchangeably with soybean, soya, soyabean, soja, and sojabean. Flour generally refers to the fact that the soy is processed. For example, it is common to process soy into soy flour by dehulling the soy, optionally defatting the soy, heat-processing the whole soybeans or defatted soybean flakes, and then grinding the heat-processed soy into fine particles.

Generally, soy flour includes fats, dietary fiber, carbohydrates, microorganisms, and proteins including amino acids such as aspartic acid, threonine, serine, glutamic acid, proline, glycine, alanine, cystine, valine, methionine, isoleucine, leucine, tyrosine, phenylalanine.

A variety of soy flour may be used in practicing the present invention. The skilled person understands that soy flour may be characterized by the manner in which it is processed. For example, mechanically extracted soy flour refers soy flour obtained by grinding low-fat press cake from soybeans that have been crushed, steamed, and hydraulically pressed to extract the soybean oil. Solvent extracted soy flour refers to soy flour that is obtained through grinding defatted flakes or meal remaining after using solvents to remove the soybean oil from crushed soybeans. Defatted soy flour is obtained from crushing and oil extraction methods that yield a low fat and higher protein content soy flour. Low-fat soy flour, also known as refatted soy flour, is obtained through the same methods as defatted soy flour, and further including adding soybean oil and/or lecithin to the defatted soy flour. Soy grits and flakes typically refer to coarsely ground soy flour and are further characterized by particle size.

The soy flour used in practicing embodiments of the invention is generally known and disclosed, for example, in U.S. Pat. No. 8,476,342, which is incorporated herein by reference. The soy flour used in practicing embodiments of the present invention may also be obtained commercially from a variety of sources. For example, useful soy flour may be obtained under the tradenames produced by ADM PRO-FAM® H200 FG (Hydrolyzed Soy Protein); PRO-FAM® 646 (Isolated Soy Protein); PRO-FAM® 780 (Isolated Soy Protein); PRO-FAM® 782 (Isolated Soy Protein); PRO-FAM® 873 (Isolated Soy Protein); PRO-FAM® 880 (Isolated Soy Protein); PRO-FAM® 892 (Isolated Soy Protein); PRO-FAM® 922 (Isolated Soy Protein); PRO-FAM® 931 (Isolated Soy Protein); PRO-FAM® 937 (Isolated Soy Protein); PRO-FAM® 976 (Isolated Soy Protein); PRO-FAM® 981 (Isolated Soy Protein); PRO-FAM® 985 (Isolated Soy Protein); ARDEX® F Dispersible (Isolated Soy Protein); ARCON® S (Soy Protein Concentrate); ARCON® SF (Soy Protein Concentrate); ARCON® SJ (Soy Protein Concentrate); ARCON® SM (Soy Protein Concentrate); ARCON® SP (Soy Protein Concentrate); ARCON® PLUS 412 (Soy Protein Concentrate); TVP® and Fortified TVP Textured Vegetable Protein 165 and 163 series; SOYLEC® C15 and 220T Soy Flours; Toasted Soy Grits; and Defatted Soy Grits. [Comprehensive list of sources Archer Daniels Midland Co. (ADM), Cargill, Central Soya Co., Inc., Ralston Purina Co.].

The protein-containing powder (e.g. soy flour) employed in the present invention may be characterized by its mean (i.e. average) particle size, which can be measured by laser diffraction using the methodologies of ASTM E2651-19. In one or more embodiments, the protein-containing powder may have a mean particle size of from about 10 μm to about 150 μm, in other embodiments from about 20 μm to about 100 μm, and in other embodiments from about 30 to about 75 μm. In certain embodiments, the protein-containing powder may have a mean particle size of greater than 30 μm, in other embodiments at least 40 μm, in other embodiments greater than 50 μm, and in other embodiments greater than 60 μm. In these or other embodiments, the protein-containing powder may have a mean particle size of less than 150 mm, in other embodiments less than 130 mm, in other embodiments less than 110 μm, in other embodiments less than 90 μm, in other embodiments less than 80 μm, and in other embodiments less than 70 μm.

The protein-containing powder (e.g. soy flour) employed in the invention may be characterized by its US sieve size. In one or more embodiments, useful protein-containing powder has as has a particle size where 99% or greater of the particles are 200 mesh or less (US sieve), or in other embodiments 100 mesh or less; i.e. 99% or greater of the particles pass through 100 mesh sieve

The protein-containing powder (e.g. soy flour) employed in the present invention may be characterized its protein content. In one more embodiments, the protein-containing powder has a protein content of from about 35 to 90 wt %, in other embodiments from about 37 to 80 wt %, in other embodiments from about 40 to 70 wt %, in other embodiments from about 42 to 65 wt %, in other embodiments from about 45 to 60 wt %, and in other embodiments from about 45 to 55 wt %. In certain embodiments, the protein-containing powder has a protein content of greater than 40 wt %, in other embodiments greater than 50 wt %, in other embodiments greater than 60 wt %, in other embodiments greater than 70 wt %, in other embodiments greater than 80 wt %, and in other embodiments greater than 90 wt %.

The protein-containing powder (e.g. soy flour) employed in the present invention may be characterized its fiber content (e.g. dietary fiber). In one or more embodiments, the protein-containing powder has a fiber content of from about 5 to about 30 wt %, in other embodiments from about 10 to about 25 wt %, and in other embodiments from about 15 to about 20 wt %. In certain embodiments, the protein-containing powder has a fiber content of greater than 1 wt %, in other embodiments greater than 11 wt %, in other embodiments greater than 13 wt %, and in other embodiments greater than 15 wt %. In these or other embodiments, the protein-containing powder has a fiber content of less than 30 wt %, in other embodiments less than 25 wt %, and in other embodiments less than 20 wt %.

The protein-containing powder (e.g. soy flour) used in the present invention may be characterized by its fat content. In one or more embodiments, the protein-containing powder has a fat content of from about 0 to about 20 wt %, in other embodiments from about 0.1 to about 15 wt %, and in other embodiments from about 0.2 to about 12 wt %. In these or embodiments, the protein-containing powder has a fat content of less than 20 wt %, in other embodiments less than 15 wt %, in other embodiments less than 10 wt %, in other embodiments less than 7 wt %, and in other embodiments less than 5 wt %.

The protein-containing powder (e.g. soy flour) employed in the present invention may be characterized by its carbohydrate content. In one or more embodiments, the protein-containing powder has a carbohydrate content of from about 15 to about 45 wt %, in other embodiments from about 20 to about 40 wt %, and in other embodiments from about 25 to about 35 wt %. In certain embodiments, the protein-containing powder has a carbohydrate content of greater than 15 wt %, in other embodiments greater than 20 wt %, in other embodiments greater than 25 wt %, in other embodiments greater than 30 wt %, and in other embodiments greater than 35 wt %. In these or other embodiments, the protein-containing powder has a carbohydrate content of less than 45 wt %, in other embodiments less than 40 wt %, and in other embodiments less than 35 wt %.

### Complementary Flame Retardants

As mentioned above, the protein-containing powder may optionally be used in conjunction with a complementary flame retardant. Flame retardants those compounds that increases the burn resistivity of the EPDM membranes.

Useful complementary flame retardants include char-forming and decomposition flame retardants. Those skilled in the art understand that char-forming flame retardants operate by forming a char-layer across the surface of a specimen when exposed to a flame. Decomposition flame retardants, on the other hand, operate by releasing water (or other flame extinguishing compound) upon thermal decomposition of the flame retardant compound. As indicated above, the complementary flame retardants may also be categorized as halogenated flame retardants or non-halogenated flame retardants.

Exemplary non-halogenated flame retardants that may be used as complementary flame retardants include magnesium hydroxide, aluminum trihydrate, zinc borate, ammonium polyphosphate, melamine polyphosphate, antimony oxide (Sb₂O₃), and expandable graphite. Ammonium polyphosphate may be used together as a polyol masterbatch. Those flame retardants from the foregoing list that are believed to operate by forming a char layer include ammonium polyphosphate and melamine polyphosphate. FILLER

As mentioned above, the vulcanizable compositions of the present invention may include filler. These fillers may include those conventionally employed in the art, as well as combinations of two or more of these fillers. In one or more embodiments, the filler may include carbon black. Examples of useful carbon blacks include those generally characterized by average industry-wide target values established in ASTM D-1765-21. Exemplary carbon blacks include GPF (General-Purpose Furnace), FEF (Fast Extrusion Furnace), and SRF (Semi-Reinforcing Furnace). One particular example of a carbon black is N650 GPF Black, which is a petroleum-derived reinforcing carbon black having an average particle size of about 60 nm and a specific gravity of about 1.8 g/cc. Another example is N330, which is a high abrasion furnace black having an average particle size about 30 nm, a maximum ash content of about 0.75%, and a specific gravity of about 1.8 g/cc.

Other useful fillers including clay and talc, such as those disclosed in U.S. Publication No. 2006/0280892, which is incorporated herein by reference. Still other useful fillers include silica, which may be used in conjunction with a coupling agent as disclosed, for example, in U.S. Publication Nos. 2015/0038031 and 2018/0179759, which are incorporated herein by reference.

### Extenders

As mentioned above, the vulcanizable compositions of the present invention may optionally include extenders. Useful extenders include paraffinic, naphthenic oils, and mixtures thereof. These oils may be halogenated as disclosed in U.S. Pat. No. 6,632,509, which is incorporated herein by reference. In one or more embodiments, useful oils are generally characterized by, low aromaticity, low volatility and a flash point of more than about 550° F. Useful extenders are commercially available. One particular extender is a paraffinic oil available under the tradename SUNPAR™ 2280 (Sun Oil Company). Another useful paraffinic process oil is Hyprene P150BS, available from Ergon Oil Inc. of Jackson, MS.

### Other Constituents

In addition to the foregoing constituents, the vulcanizable composition of this invention may also optionally include mica, coal filler, ground rubber, titanium dioxide, calcium carbonate, silica, homogenizing agents, phenolic resins, flame retardants, zinc oxide, stearic acid, and mixtures thereof as disclosed in U.S. Publication No. 2006/0280892, which is incorporated herein by reference. Certain embodiments may be substantially devoid of any one or more of these constituents.

### Amounts

In one or more embodiments, the vulcanizable compositions used to prepare the one or more layers of the membranes of this invention (which include protein-containing powder) include from about 20 to about 50 percent by weight rubber, in other embodiments from about 24 to about 36 percent by weight rubber, and in other embodiments from about 28 to about 32 percent by weight rubber (e.g., EPDM) based on the entire weight of the membrane.

In one or more embodiments, the vulcanizable compositions used to prepare the one or more layers of the membranes of this invention include from about 0.01 to about 10, in other embodiments from about 0.1 to about 8, in other embodiments from about 0.5 to about 6, in other embodiments from about 1 to about 5, and in other embodiments from about 2 to about 4 parts by weight (pbw) protein-containing powder (e.g. soy flour) per 100 parts by weight rubber (phr) (e.g. EPDM). In certain embodiments, the vulcanizable compositions of this invention include less than 10 pbw, in other embodiments less than 9 pbw, in other embodiments less than 8 pbw, in other embodiments less than 7 pbw, in other embodiments less than 6 pbw, in other embodiments less than 5 pbw, and in other embodiments less than 4 pbw protein-containing powder phr. In these or other embodiments, the vulcanizable compositions of this invention include greater than 0.1 pbw, in other embodiments greater than 0.5 pbw, in other embodiments greater than 0.7 pbw, in other embodiments greater than 1 pbw, in other embodiments greater than 1.5 pbw, in other embodiments greater than 2 pbw, and in other embodiments greater than 3 pbw protein-containing powder phr.

In one or more embodiments, the vulcanizable compositions used to prepare the one or more layers of the membranes of this invention may include from about 55 to about 100 pbw, in other embodiments from about 75 to about 95 pbw, and in other embodiments from about 77 to about 85 parts by weight carbon black per 100 pbw phr. Certain embodiments may be substantially devoid of carbon black.

In one or more embodiments, the vulcanizable compositions used to prepare the one or more layers of the membranes of this invention may include from about 78 to about 130 pbw, in other embodiments from about 85 to about 100 pbw, and in other embodiments from about 87 to about 98 pbw clay per 100 pbw phr. Certain embodiments may be substantially devoid of clay.

In one or more embodiments, the vulcanizable compositions used to prepare the one or more layers of the membranes of this invention may include from 5 to about 60 pbw, in other embodiments from about 10 to about 40 pbw, and in other embodiments from about 20 to about 25 pbw talc per 100 pbw phr. Certain embodiments may be substantially devoid of talc.

In one or more embodiments, the vulcanizable compositions used to prepare the one or more layers of the membranes of this invention may include from about 55 to about 95 pbw, in other embodiments from about 60 to about 85 pbw, and in other embodiments from about 65 to about 80 pbw extender per 100 pbw phr. Certain embodiments may be substantially devoid of extender.

In one or more embodiments, the vulcanizable compositions used to prepare the one or more layers of the membranes of this invention include from about 12 to about 25 pbw mica per 100 pbw phr. In other embodiments, the membrane includes less than 12 pbw phr mica, and in other embodiments less than 6 pbw mica phr. In certain embodiments, the membrane is devoid of mica.

In one or more embodiments, the vulcanizable compositions used to prepare the one or more layers of the membranes of this invention may include from about 10 to about 100 pbw silica phr. In other embodiments, the vulcanizable compositions include less than 70 pbw silica phr, and in other embodiments less than 55 pbw silica phr. In certain embodiments, the membrane is devoid of silica.

In one or more embodiments, the vulcanizable compositions used to prepare the one or more layers of the membranes of this invention include from about 2 to about 10 pbw homogenizing agent phr. In other embodiments, the membrane includes less than 5 pbw homogenizing agent phr, and in other embodiments less than 3 pbw homogenizing agent phr. In certain embodiments, the membrane is devoid of homogenizing agent.

In one or more embodiments, the vulcanizable compositions used to prepare the one or more layers of the membranes of this invention include from about 2 to about 10 pbw phenolic resin phr. In other embodiments, the membrane includes less than 4 pbw phenolic resin phr, and in other embodiments less than 2.5 pbw phenolic resin phr. In certain embodiments, the membrane is devoid of phenolic resin.

In one or more embodiments, the vulcanizable compositions used to prepare the one or more layers of the membranes of this invention (or one or more layers of a multi-layered membrane) including protein-containing powder are devoid or substantially devoid of halogen-containing flame retardants. In one or more embodiments, the membranes or the layers of a membrane including protein-containing powder include less than 5 pbw, in other embodiments less than 3 pbw, and in other embodiments less than 0.1 pbw halogen-containing flame retardant phr. In particular embodiments, the membranes of the present invention are substantially devoid of DBDPO.

### Methods of Manufacture

Practice of embodiments of the present invention is not limited by the methods used to prepare the vulcanizable compositions or the roofing membranes of this invention. For example, convention techniques can be employed, which includes preparing the vulcanizable compositions by using conventional batch mixing techniques, calendaring a sheet, fabricating a green membrane, curing the green membrane to form a cured membrane, and then optionally finishing the membrane to ultimately form a roll for shipping.

Conventional rubber mixing, also referred to as rubber compounding, can employ a variety of mixing equipment such as Brabender mixers, Banbury mixers, Sigma-blade mixers, two-roll mills, or other mixers suitable for forming viscous, relatively uniform admixtures. Mixing techniques depend on a variety of factors such as the specific types of polymers used, and the fillers, processing oils, waxes and other ingredients used. In one or more embodiments, the ingredients can be added together in a single shot. In other embodiments, some of the ingredients such as fillers, oils, etc. can first be loaded followed by the polymer. In other embodiments, a more conventional manner can be employed where the polymer added first followed by the other ingredients. These techniques are generally known in the art as disclosed in U.S. Publication Nos. 2014/0373467, 2006/0280892, 2008/0097004, 2016/0221309, which are incorporated herein by reference.

Mixing cycles generally range from about 2 to 6 minutes. In certain embodiments an incremental procedure can be used whereby the base polymer and part of the fillers are added first with little or no process oil, the protein-containing powder, the remaining fillers and process oil are added in additional increments. In other embodiments, part of the EPDM can be added on top of the fillers, plasticizers, etc. This procedure can be further modified by withholding part of the process oil, and then adding it later. In one or more embodiments, two-stage mixing can be employed.

The sulfur cure package (sulfur/accelerator) can be added near the end of the mixing cycle and at lower temperatures to prevent premature crosslinking of the EPDM polymer chains. When utilizing a type B Banbury internal mixer, the dry or powdery materials such as the carbon black and non-black mineral fillers (i.e., untreated clay, treated clays, talc, mica, and the like) can be added first, followed by the liquid process oil and finally the polymer (this type of mixing can be referred to as an upside-down mixing technique).

Once mixed, the rubber composition can then be formed into a sheet via calendering. The compositions of the invention can also be formed into various types of articles using other techniques such as extrusion.

Methods also exist for the continuous manufacture of vulcanizable compositions of matter that are useful for forming roofing membranes. In this regard, U.S. Publication No. 2015/0076743 is incorporated herein by reference.

The resultant vulcanizable compositions may be prepared in sheet form in any known manner such as by calendering or extrusion. The sheet may also be cut to a desired dimension. In one or more embodiments, the resulting admixture can be sheeted to thicknesses ranging from 5 to 200 mils, in other embodiments from 35 to 90 mils, by using conventional sheeting methods, for example, milling, calendering or extrusion. In one or more embodiments, the admixture is sheeted to at least 40 mils (0.040-inches), which is the minimum thickness specified in manufacturing standards established by the Roofing Council of the Rubber Manufacturers Association (RMA) for non-reinforced EPDM rubber sheets for use in roofing applications. In other embodiments, the admixture is sheeted to a thickness of about 45 mils, which is the thickness for a large percentage of “single-ply” roofing membranes used commercially. The sheeting can be visually inspected and cut to the desired length and width dimensions after curing. The membranes of the present invention can be optionally reinforced with scrim. In other embodiments, the membranes are devoid of scrim. The skilled person understands that reinforcement can be included into the membrane by sandwiching the fabric between two layers of rubber sheet. Each rubber sheet may derive from the same or different vulcanizable compositions. As noted above, at least one of the rubber layers is prepared from the vulcanizable composition including protein-containing powder.

The green membrane is then subjected to curing conditions. This can take place using conventional batch procedures where the membrane is rolled and cured in an oven, optionally under pressure, such as is accomplished within an autoclave. The skilled person understands that efforts must be undertaken to ensure that the membrane does not cure to itself when rolled. For example, the green membrane can be dusted (e.g. talc) or rolled with a curing liner prior to curing. In the alternative, curing can take place continuously using known technologies. In this regard, U.S. Publication Nos. 2015/0076743 and 2001/0027224 are incorporated herein by reference.

Where the membranes of this invention include distinct layers that derive from distinct vulcanizable compositions, the vulcanizable compositions that do not include protein-containing powder can be conventional in nature. In this regard, U.S. Pat. Nos. 7,175,732, 6,502,360, 6,120,869, 5,849,133, 5,389,715, 4,810,565, 4,778,852, 4,732,925, and 4,657,958 are incorporated herein by reference.

### Membrane Installation

The membranes of this invention may be unrolled over a roof substructure in a conventional fashion, wherein the seams of adjacent sheets are overlapped and mated by using, for example, an adhesive. The width of the seam can vary depending on the requirements specified by the architect, building contractor, or roofing contractor, and they thus do not constitute a limitation of the present invention. Seams can be joined with conventional adhesives such as, for instance, a butyl-based lap splice adhesive, which is commercially available under the tradename SA-1065 (ELEVATE). Application can be facilitated by spray, brush, swab or other means known in the art. Also, field seams can be formed by using tape and companion primer such as QuickSeam™ (ELEVATE) tape and Quick Prime Plus primer (ELEVATE).

Also, as is known in the art, these membranes can be secured to the roof substructure by using, for example, mechanical fasteners, adhesives (which are often employed to prepare a fully-adhered roofing system), or ballasting. In particular embodiments, the membranes of the present invention can be formed into a composite by applying a layer of pressure-sensitive adhesive (e.g. UV-curable adhesive) as disclosed in U.S. Pat. Nos. 10,065,394, 10,132,082, 10,260,237, and 10,370,854. Furthermore, the membranes of this invention are useful in combination with insulation or coverboards or in composite boards as disclosed in U.S. Pat. No. 7,972,688, which is incorporated herein by reference. It is also contemplated to use the concepts of the present invention in EPDM flashings such as those disclosed in U.S. Pat. No. 5,804,661, which is also incorporated herein by reference.

### Roof System

As indicated above, the membranes of the present invention can be used to create a roof system. These roof systems may include flat or low-slope roofing system. Sloped roof systems typically have a slope of at least 0.25:12 (rise over run), and can include roofs with slope of 1:12, or 2:12 (low sloped), or 3:12, or 5:12.

Exemplary roof systems can be understood with reference to FIG. 1, which shows roofing system 30 including a roof deck 32, an insulation layer 34, an optional high cover board layer 36, and a membrane layer 38. As shown, membrane layer 38 forms the outermost element of system 30, with cover board layer 36 disposed below the membrane, insulation layer 34 disposed below cover board layer 36, and insulation layer 34 disposed above deck 32.

Practice of this invention is not limited by the selection of any particular roof deck. Accordingly, the roofing systems of this invention can include a variety of roof decks including both combustible and non-combustible decks. Exemplary roof decks include concrete pads, steel decks, wood beams, and foamed concrete decks.

Practice of the invention is not necessarily limited by the selection of insulation layer 34 or cover board layer 36. For example, insulation layer 34 can include polyisocyanurate foam, which may be provided as board stock. In this respect, U.S. Publication Nos. 2004/0082676, 2004/0102537, and 2022/0049063 are incorporated herein by reference. Likewise, cover board layer 36 can include a variety of materials include wood strand board, gypsum, perlite, and high-density foam such as polyisocyanurate board. In this respect, U.S. Publication Nos. 2006/0179749 and 2001/0214387 are incorporated herein by reference.

The various layers of system 30 can be secured to the deck by using various known techniques. For example, in one or more embodiments, one or more of the layers can be mechanically fastened to roof deck 32. In lieu or in combination therewith, one or more layers can be adhesively secured to the layer disposed immediately below. For example, insulation layer 34 and/or cover board layer 36 can be mechanically fastened and then membrane layer 38 can be adhesively fastened.

### Membrane and System Performance Standards

In one or more embodiments, the membranes of the invention can be used to create a Class A roof system over a non-combustible deck pursuant to ASTM E108-20a. In one or more embodiments, the Class A roof system has a slope of greater than or equal to 0.25:1:12, in other embodiments greater than or equal to 2:12, in other embodiments greater than 3:12, and in other embodiments greater than 5:12. In these or other embodiments, the membranes can be used to create a Class A roof system over a combustible deck pursuant to ASTM E108-20a. In one or more embodiments, the Class A roof system has a slope of greater than or equal to 1:12, in other embodiments greater than or equal to 2:12.

In one or more embodiments, the membranes of the present invention meet the performance standards of ASTM D 4637/D4637M-15 (Reapproved 2021).

### Examples

In order to demonstrate the practice of the present invention, the following examples have been prepared and tested. The examples should not, however, be viewed as limiting the scope of the invention. The claims will serve to define the invention. Samples 1-3

Three rubber formulations were prepared and tested for processing properties. The formulations were mixed by employing a two-step mixing procedure. The soy flour that was used was characterized by a particle size of 100 mesh (i.e. less than 149 microns particle size). The EPDM formula used for each of the three samples was the same except as noted in Table I below.

TABLE I

| | Sample | Sample | Sample |
|---|---|---|---|
| Ingredient | 1 | 2 | 3 |
| Soy Flour, wt % | 1.98 | 3.89 | 0.00 |
| Soy Flour (pbw/phr) | 7 | 14 | 0 |
| Clay (pbw/phr) | 114 | 114 | 120 |

Processing Properties

| | | | |
|---|---|---|---|
| Master Batch ML1 + 4 at 135° C. (MU) | 64.2 | 64.7 | 59.8 |
| Final Batch ML1 + 4 at 135° C. (MU) | 55.7 | 58.5 | 49.9 |

The processing properties of each composition were evaluated within a Rubber Processing Analyzer set at 160° C. for 45 minutes at 100 cycles per minute and 0.5°. The analyzer was set to mimic a moving die Rheometer (MDR) at 1.1. The results of the test data are provided in Table I.

The relevant ingredients employed in each sample, together with the results of physical testing and burn resistivity testing, are provided in Table II. Physical testing was performed in accordance with the standards set forth in ASTM D4637/D4637M-15 (Reapproved 2021), which is incorporated herein by reference.

TABLE II

| Ingredient | Sample 1 | Sample 2 | Sample 3 |
|---|---|---|---|
| Soy Flour | 1.98 | 3.89 | 0.00 |

Testing
Mooney Scorch, 40 min @ 135° C.

| | | | |
|---|---|---|---|
| Min. Viscosity (MU) | 56.53 | 61.14 | 46.4 |
| Final Viscosity (MU) | 91.5 | 93 | 81.7 |
| T5 Minutes | 20.03 | 21.82 | 21.26 |

RPA (MDR mimic) at 160° C.

| | | | |
|---|---|---|---|
| ML (dNm) | 2.11 | 2.6 | 1.57 |
| MH (dNm) | 17.18 | 17.5 | 16.28 |
| MH − ML | 15.07 | 14.9 | 14.71 |
| ts2 (minutes) | 5.54 | 5.17 | 8.88 |
| t′90 (minutes) | 26.82 | 21.64 | 40.48 |

ASTM D412 Tensile Properties (unaged)

| | | | |
|---|---|---|---|
| 100% Modulus (MPa) | 3.19 | 3.59 | 2.39 |
| 300% Modulus (MPa) | 6.62 | 6.28 | 5.19 |
| Tensile Strength (MPa) | 10.76 | 9.91 | 12.82 |
| Elongation (%) | 562 | 588 | 732 |

ASTM D412 Tensile Properties (aged)

| | | | |
|---|---|---|---|
| 100% Modulus (MPa) | 6.96 | 8.27 | 5.95 |
| 300% Modulus (MPa) | 10.00 | 11.03 | 9.72 |
| Tensile Strength (MPa) | 11.72 | 12.07 | 11.72 |
| Elongation (%) | 317 | 282 | 285 |

ASTM Die C Tear (unaged)

| | | | |
|---|---|---|---|
| MD Load Thickness @ Max | 223.8 | 242.1 | 214.2 |
| Load (lb f/in) | | | |

Flame Resistance

| | | | |
|---|---|---|---|
| Spread of Flame (inches) | 6.00 | 3.38 | 6.63 |
| Weight loss, g | 15.14 | 7.06 | 24.22 |

Various modifications and alterations that do not depart from the scope and spirit of this invention will become apparent to those skilled in the art. This invention is not to be duly limited to the illustrative embodiments set forth herein.

1. A roofing membrane comprising:
a cured EPDM rubber matrix having protein-containing powder dispersed therein.

2. The roofing membrane of claim 1, where the protein-containing powder is selected from the group consisting of soy flour, chicken feather flour, and pig hair flour.

3. (canceled)

4. The roofing membrane of claim 1, where the membrane is single ply membrane having at least one rubber layer in which the protein-containing powder is dispersed.

5. The roofing membrane of claim 4, where the at least one layer including the protein-containing powder includes from about 0.1 to about 20 parts by weight protein-containing powder per 100 parts by weight rubber.

6. The roofing membrane of claim 1, where EPDM is sulfur cured.

7. The roofing membrane of claim 1, where the membrane includes distinct rubber layers and at least one of the rubber layers includes the protein-containing powder.

8. The roofing membrane of claim 1, further comprising carbon black dispersed within the cured EPDM rubber matrix.

9. The roofing membrane of claim 4, where the at least one layer in which the protein-containing powder is dispersed further includes carbon black or silica, and optionally flame retardant.

10. The roofing membrane of claim 1, further comprising silica dispersed within the cured EPDM rubber matrix.

11. (canceled)

12. The roofing membrane of claim 1, further comprising a flame retardant within the cured EPDM rubber matrix.

13. (canceled)

14. The roofing membrane of claim 1, where the cured EPDM rubber matrix is devoid of flame retardant.

15. The roofing membrane of claim 4, where the at least one layer in which the protein-containing powder is dispersed is devoid of flame retardant.

16. The roofing membrane of claim 1, where the protein-containing powder has a particle size of from about 10 to about 150 micrometers, as measured by laser diffraction.

17. The roofing membrane of claim 1, where at least 99% of the protein-containing powder has a mesh size of 100 or less (US sieve).

18. The roofing membrane of claim 1, where the membrane meets the performance standard of ASTM D 4637/D4637M-15 (Reapproved 2021).

19. The roofing membrane of claim 1, where the membrane is fabric reinforced.

20. The roofing membrane of claim 1, where the membrane has a thickness of from about 20 to about 100 mils.

21. A roof system including the roofing membrane of claim 1.

22. The roof system of claim 21, where the roof system includes combustible deck, where the roof system is a Class A roof system according to ASTM E108-20a, and where the roof system has a slope of 3:12 or more.

23. The roof system of claim 21, where the roof system includes a non-combustible deck.

24. (canceled)

25. (canceled)

26. (canceled)
